(19) United States
(12) Patent Application Publication
(10) Pub. No.: US 2023/0404174 A1
(43) Pub. Date: Dec. 21, 2023

(54) EASY-TO-CLEAN WATERPROOF AND BREATHABLE BIB FABRIC, PREPARATION METHOD THEREOF AND BIB INCLUDING THE SAME

(71) Applicant: WUYUAN YUCHEN BABY PRODUCTS CO., LTD, Jiangxi (CN)

(72) Inventor: Huafei WU, Jiangxi (CN)

(73) Assignee: WUYUAN YUCHEN BABY PRODUCTS CO., LTD, Jiangxi (CN)

(21) Appl. No.: 18/337,447

(22) Filed: Jun. 20, 2023

(30) Foreign Application Priority Data
Jun. 20, 2022 (CN) 202221547711.7

(51) Int. Cl. A41B 13/10; D06N 3/00; D06N 3/18; D06N 3/14; D06N 3/04; B32B 7/12; B32B 5/02; B32B 5/26; B32B 37/24; B32B 37/12

(52) U.S. Cl. CPC A41B 13/10; D06N 3/0006; D06N 3/183; D06N 3/14; D06N 3/0015; D06N 3/042; D06N 3/0059; B32B 7/12; B32B 5/024; B32B 5/263; B32B 37/24; D06N 3/0013; D06N 3/0088; B32B 37/12; D06N 2209/1635; D06N 2209/142; D06N 2209/145; D06N 2211/10; B32B 2375/00; D06N 2209/128; D06N 2201/085; B32B 2037/243; B32B 2250/02; B32B 2250/20; B32B 2305/188; B32B 2255/02; B32B 2255/28; B32B 2255/26; B32B 2262/103; B32B 2262/0292; B32B 2307/73; B32B 2307/724; B32B 2307/7265; B32B 2307/21; B32B 2437/00; B32B 2333/08; A41B 2400/22; A41B 2500/20

(57) ABSTRACT

The invention involves the technical field of daily necessities, and in particular, relates to an easy-to-clean waterproof and breathable bib fabric, a preparation method, and a bib. A layer structure of the bib fabric is as follows: a hydrophobic and oleophobic surface layer, a polyurethane waterproof layer, an antibacterial and antistatic layer, and a woven layer. The hydrophobic and oleophobic surface layer has waterproof and breathable properties, is not easy to be adhered to by dirt, and is easy to clean. The polyurethane waterproof layer keeps liquids from penetrating the fabric, and the porous structure also allows for breathability. The antibacterial and antistatic layer can remove the static electricity generated by the fabric, protect the polyurethane waterproof layer from being decomposed by molds, inhibit the growth of bacteria inside the woven layer, and produce antibacterial and deodorizing effects. Further, a bib using the fabric and a preparation method are provided.

### CROSS-REFERENCE TO RELATED APPLICATION

This application claims the priority benefit of China application serial no. 202221547711.7, filed on Jun. 20, 2022. The entirety of the above-mentioned patent application is hereby incorporated by reference herein and made a part of this specification.

### BACKGROUND

### Technical Field

The disclosure belongs to the technical field of daily necessities, and in particular, relates to an easy-to-clean waterproof and breathable bib fabric, a preparation method, and a bib.

### Description of Related Art

Children are prone to soiling their clothes when they are just learning to eat or when they have already learned to eat. Especially when children are being fed, the food is easy to drop on the clothes. A child can always soil a whole suit of clothes with just a bite of food. In order to alleviate the burden, at present, adults will wrap cloth bibs or directly wrap three-dimensional bibs made of silica gel or plastic materials around children's necks. A cloth bib is breathable and light, but it is easy to be stained with food residues and difficult to clean. Further, liquid food can easily penetrate the cloth bib, so the cloth bib cannot provide effective protection. The three-dimensional bibs made of silica gel or plastic materials do not absorb water. Although the three-dimensional bibs made of silica gel or plastic materials are easy to clean and can catch food to reduce food splashes, they are heavy and will increase the burden on children's necks. Further, the three-dimensional bibs made of silica gel or plastic materials are not breathable and can easily cause discomfort to children's delicate skin if worn for a long time.

### SUMMARY

The disclosure aims to solve the problems found in the related art and provides an easy-to-clean waterproof and breathable bib fabric and a bib using the bib fabric which has the waterproofness of a silicone bib or a plastic bib but is lighter and thinner than the silicone bib or the plastic bib, and has the same breathability as a cloth bib.

The disclosure further provides a method for preparing the bib fabric.

The technical solutions adopted by the disclosure are provided as follows.

The disclosure provides an easy-to-clean waterproof and breathable bib fabric. A layer structure of the fabric is as follows: a hydrophobic and oleophobic surface layer, a polyurethane waterproof layer, an antibacterial and antistatic layer, and a woven layer. The hydrophobic and oleophobic surface layer is arranged on an outermost side of the bib fabric. The hydrophobic and oleophobic surface layer is coated on the polyurethane waterproof layer. The polyurethane waterproof layer is attached to an outer surface of the antibacterial and antistatic layer. An inner surface of the antibacterial and antistatic layer is tightly connected to one surface of the woven layer by an adhesive. The other surface of the woven layer is an innermost side of the fabric, and the four-layered structure is tightly combined to form a whole.

The disclosure further provides a bib for storing food residues and a bib cloth made of the abovementioned fabric. The bib cloth and the bib body are sewn together or both are detachably connected.

The disclosure further provides a preparation method of the easy-to-clean waterproof and breathable bib fabric, and the method includes the following steps.

In step 1, the woven layer and the antibacterial and antistatic layer are bonded by a thermosetting polyurethane adhesive by thermocompression to prepare a two-layered water proof and breathable bib fabric.

In step 2, a polyurethane waterproof layer stock solution is prepared. 100 parts of DMF is used, 5-10 parts of cellulose powder, 1-5 parts of nano-silver powder, 2-4 parts of ionic active agent, 0.1-0.5 part of defoaming agent, 0.1-0.3 part of leveling agent, and 0.1-0.3 part of anti-sticking agent are added. After stifling for 10-20 minutes, 80-100 parts of polyurethane emulsion are then added and stirred at high speed for 10-20 minutes for later use, and the mass percentage of the polyurethane resin is 30%.

In step 3, the two-layered waterproof and breathable bib fabric prepared in step 1 is immersed in clear water, and then the two-layered waterproof and breathable bib fabric is ironed to half-dry by an ironing wheel.

In step 4, the polyurethane waterproof layer stock solution prepared in step 2 is uniformly coated on the antibacterial and antistatic layer of the two-layered waterproof and breathable bib fabric obtained in step 3 with a scraper.

In step 5, the waterproof and breathable bib fabric prepared in step 4 is put into a coagulation solution for 5-10 minutes, and the coagulation solution is composed of water and DMF.

In step 6, the waterproof and breathable bib fabric prepared in step 5 is put into a washing tank for washing, and the liquid in the washing tank is pure water.

In step 7, the waterproof and breathable bib fabric prepared in step 6 is dried at 120-150° C. for 10-30 minutes.

In step 8, a water-repellent and oil-repellent agent is applied to the polyurethane waterproof layer of the waterproof and breathable bib fabric prepared in step 7, and then the obtained easy-to-clean waterproof and breathable bib fabric is dried at 120-140° C.

Beneficial effects provided by the disclosure include the following.

1. By using the polyurethane waterproof layer, the polyurethane waterproof layer itself is porous and exhibits waterproof and breathable properties, so the fabric obtains waterproof and breathable properties. Further, the water-repellent and oil-repellent agent is coated on the polyurethane waterproof layer as the surface layer, and the water repellency increases the waterproof performance of the polyurethane coating. Moreover, the water-repellent and oil-repellent properties make the fabric not adhere to food residues during use, and food falling on it can slide down into the bib body for easy cleaning.

2. The antibacterial and antistatic layer is added under the polyurethane waterproof layer. The polyurethane waterproof layer is easy to be decomposed by molds due to structural reasons of polyester, resulting in tiny cracks and losing the waterproof function. By compounding the antibacterial and antistatic layer under the polyurethane waterproof layer, the polyurethane waterproof layer is effectively protected from being decomposed by molds. Further, bacteria are inhibited from growing inside the fabric and odor is prevented from being produced after the sweat is absorbed by the fabric. The static electricity generated on the fabric can be eliminated, making it more comfortable to wear.

3. The antibacterial and antistatic layer formed by blending spandex and silver fibers makes the antibacterial and antistatic layer have certain elasticity and provide soft hand feeling.

4. The antibacterial and antistatic layer and the woven layer are connected through the thermosetting polyurethane adhesive. The thermosetting polyurethane adhesive can be cured at a relatively low temperature and exhibits good adhesion performance, so the delamination of the fabric during use can be effectively prevented.

5. The woven twill fabric is soft to the touch, and the overall fabric after compounding is soft, light, waterproof, breathable, and easy to clean.

6. The bib cloth can be sewn with a silicone or plastic bib body that can maintain a certain shape. The bib body can accommodate the fallen food residues to prevent food residues from polluting other places. Further, the bib body can be detachably connected selectively, and the bib body can be removed and cleaned directly, which is more convenient to use.

7. The reinforcing connecting ear piece is provided on one side of the second strap. The reinforcing connecting ear piece covers the connection between the first strap and the second strap and are connected to the second strap. In this way, when the child pulls the bib, the first and second straps are prevented from being separated, thereby ensuring the effectiveness of the protection during the use of the bib.

8. The first strap is connected to the main connecting zone of the second strap. The head portion of the reinforcing connecting ear piece is connected to the secondary connecting zone of the second strap through the hook-and-loop fastener or the snap button. In this way, the connection is made stronger, and the hook-and-loop fastener or snap button connection method does not cause inconvenience to wearing and removing.

9. The front and back surfaces of the first strap are provided with hook-and-loop fasteners or snap buttons. The reinforcing connecting ear piece is correspondingly provided with a hook-and-loop fastener or a snap button for connection. After the back surface of the first strap is connected to the second strap, the front surface of the first strap is then connected to the reinforcing connecting ear piece. The reinforcing connecting ear piece is connected to the second strap and at the same time connected to the first strap, which further strengthens the connection and does not cause trouble for wearing and detaching.

10. The woven layer and the antibacterial and antistatic layer are bonded by the thermosetting polyurethane. The polyurethane waterproof layer is coated on the antibacterial and antistatic layer, the water-repellent and oil-repellent finishing is then carried out on the polyurethane waterproof layer, and the easy-to-clean waterproof and breathable bib fabric is thus obtained. Nano-silver powder is added in the polyurethane waterproof layer stock solution to act as a “crystal nucleus” during the solidification process of the polyurethane waterproof layer, making the solidification process more uniform. Further, nano-silver powder has antibacterial properties, which can prevent mold from destroying polyurethane resin, so that the service life of bib fabric can be prolonged. After the polyurethane waterproof layer stock solution is coated on the antibacterial and antistatic layer, the bib fabric is placed in the coagulation solution. The DMF in the polyurethane waterproof layer stock solution is replaced with water, and the DMF migrates to the water quickly, while the water penetrates into the material layer at a slower speed. When the concentration of DMF in the coated layer drops to a certain level, the dissolved polyurethane solidifies to form a porous polyurethane waterproof layer. Therefore, the function of breathability and waterproof is provided, and then the upper surface of the polyurethane waterproof layer is treated with water and oil repellency, and the bib fabric thus exhibits the property of being easy to clean.

11. By controlling the DMF content in the coagulation solution within the range of 12-16%, a suitable solidification speed of the polyurethane coating layer can be obtained, and the shrinkage ratio of the obtained polyurethane waterproof coating layer is within the range of 0.1-0.3%.

12. The addition of pyridine water-repellent agents to fluorine-containing hydrocarbon compounds does not affect the original oil-repellent effect of fluorine-containing hydrocarbon compounds, and its water repellency and washability can also be improved. In this way, the water-repellent grade of the easy-to-clean waterproof and breathable bib fabric reaches 5-6 grades.

### BRIEF DESCRIPTION OF THE DRAWINGS

FIG. 1 is a schematic structural cross-sectional view of the disclosure.

FIG. 2 is a schematic view of the disclosure.

FIG. 3 is a schematic view of the disclosure after a reinforcing connecting ear piece is connected.

### DESCRIPTION OF REFERENCE NUMERALS

1. hydrophobic and oleophobic surface layer; 2. polyurethane waterproof layer; 3. antibacterial and antistatic layer; 4. woven layer; 11. bib cloth; 12. bib body; 13. secondary connecting zone; 14. reinforcing connecting ear piece; 15. second strap; 16. main connecting zone; 17. first strap; 18. male tape; 19. female tape; 20. male button; 21. female button.

### DESCRIPTION OF THE EMBODIMENTS

The technical solutions of the embodiments of the disclosure will be explained and described below together with the accompanying drawings of the disclosure. However, the following embodiments are only preferred embodiments of the disclosure, not all the embodiments. Based on the embodiments in the implementation manners, other embodiments obtained by a person having ordinary skill in the art without making creative efforts all belong to the protection scope of the disclosure.

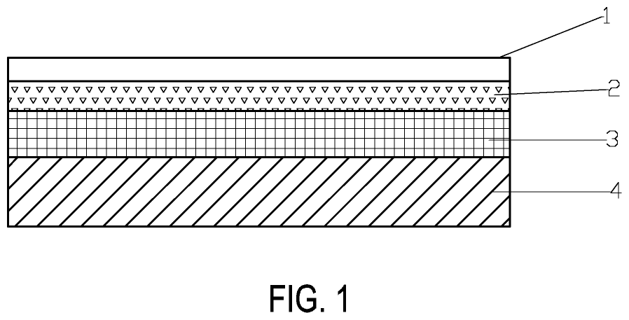

Example 1: With reference to FIG. 1, an easy-to-clean waterproof and breathable bib fabric includes a hydrophobic and oleophobic surface layer 1, a polyurethane waterproof layer 2, an antibacterial and antistatic layer 3, and a woven layer 4. The hydrophobic and oleophobic surface layer 1 is arranged on an outermost side of the bib fabric. The hydrophobic and oleophobic surface layer 1 is coated on an upper surface of the polyurethane waterproof layer 2. The hydrophobic and oleophobic surface layer 1 is a composite coating material and is generally a fluorine-containing hydrocarbon compound. By brushing a layer of water-repellent and oil-repellent agent on the surface of the polyurethane waterproof layer 2, the hydrophobicity of the water-repellent and oil-repellent agent is used to make water unable to wet. Further, good breathability is maintained, and good breathability contributes to improved wearing comfort. Moreover, the hydrophobic and oleophobic properties can prevent the fabric from being polluted by oil stains or stains and do not affect the subsequent use of the product. The product is less likely to stick to dirt and is easier to clean.

The polyurethane waterproof layer 2 is attached to an outer surface of the antibacterial and antistatic layer 3. The polyurethane waterproof layer 2 is prepared by dissolving polyurethane granules to form a paint, which is coated on the outer surface of the antibacterial and antistatic layer 3 by a coating machine, and dried and cured to form the polyurethane waterproof layer 2. In the disclosure, the hydrophobic and oleophobic surface layer 1 is printed by covert printing, so the hydrophobic and oleophobic surface layer 1 will not appear under normal conditions. Therefore, patterns and the like can be printed on the surface of the polyurethane waterproof layer 2 to improve the aesthetics of the bib.

The antibacterial and antistatic layer 3 is selectively made of blending and weaving silver fibers and spandex. Silver has safe, efficient, and broad-spectrum antibacterial properties, which can effectively kill fungi and harmful bacteria. Silver fiber sterilization is contact sterilization, non-dissolution, and harmless to human body. The polyurethane waterproof layer 2 is easy to be decomposed by molds due to molecular structure reasons, resulting in tiny cracks and losing the waterproof function. By adding the antibacterial and antistatic layer 3 under the polyurethane waterproof layer 2, the polyurethane waterproof layer 2 can be effectively protected, and the service life of the polyurethane waterproof layer 2 can be extended. Further, as a metal conductive material, silver fibers can effectively remove the static electricity generated by a bib cloth 11, and the blending of the spandex and the nano-silver fibers makes the antibacterial and antistatic layer 3 soft and elastic.

An inner surface of the antibacterial and antistatic layer 3 is tightly connected to one surface of the woven layer 4 by an adhesive. The thermosetting polyurethane used as the adhesive is coated on an upper surface of the woven layer 4 and attached to the antibacterial and antistatic layer 3. The antibacterial and antistatic layer 3 and the woven layer 4 are then closely bonded together after heating, curing, and crosslinking. The thermosetting polyurethane adhesive can be cured at a relatively low temperature and exhibits good adhesion performance, so the delamination of the fabric during use can be effectively prevented.

A lower surface of the woven layer 4 is in contact with the skin, and the antibacterial and antistatic layer 3 is closely connected to the upper surface of the woven layer 4. In this way, bacteria are inhibited from growing inside the fabric, the sweat absorbed by the fabric is prevented from producing odor under the action of bacteria, and a good antibacterial and deodorizing effect is obtained. The woven layer 4 is selected from a woven twill fabric. The woven twill fabric feels softer, and cotton and linen woven twill fabrics can be used, so it is more skin-friendly. The four-layered structure is tightly combined to form a whole, which is used as a bib fabric and has the properties of easy cleaning, waterproof, softness, and breathability.

A processing method of the abovementioned fabric is introduced in detail below:

In step 1, the woven layer 4 and the antibacterial and antistatic layer 3 are bonded by a thermosetting polyurethane adhesive by thermocompression to prepare a two-layered water proof and breathable bib fabric. The thermosetting polyurethane adhesive is coated on the woven layer 4, and then the antibacterial and antistatic layer 3 is attached and dried at 150° C. for 10 minutes.

In step 2, a polyurethane waterproof layer stock solution is prepared. 100 parts of DMF is used, 5 parts of cellulose powder, 2 parts of nano-silver powder, 2 parts of ionic active agent, 0.1 part of defoaming agent, 0.1 part of leveling agent, and 0.2 part of anti-sticking agent are added. After stifling for 15 minutes, 90 parts of polyurethane emulsion are then added and stirred at high speed for 15 minutes for later use, and the content of the polyurethane resin is 30%. DMF is mainly used as a solvent for polyurethane resin. The purpose of adding cellulose is mainly to improve the hygroscopic performance of the polyurethane waterproof layer and reduce costs. Nano-silver powder is added to act as a “crystal nucleus” during the solidification process of the polyurethane waterproof layer, making the solidification process more uniform. Further, nano-silver powder has antibacterial properties, which can prevent mold from destroying polyurethane resin, so that the service life of bib fabric can be prolonged.

In step 3, the two-layered waterproof and breathable bib fabric prepared in step 1 is immersed in clear water, and then the two-layered waterproof and breathable bib fabric is ironed to half-dry by an ironing wheel. The two-layered waterproof and breathable bib fabric is immersed in water to increase the humidity of the fabric and prevent the polyurethane waterproof layer stock solution to be coated from excessively penetrating into the base fabric. Further, the hydrophilicity of the base fabric having poor degreasing properties is improved.

In step 4, the polyurethane waterproof layer stock solution prepared in step 2 is uniformly coated on the antibacterial and antistatic layer of the two-layered waterproof and breathable bib fabric obtained in step 3 with a scraper.

In step 5, the waterproof and breathable bib fabric prepared in step 4 is put into a coagulation solution for 7 minutes, and the coagulation solution is composed of water and DMF, where the content of DMF is 15%.

By controlling the DMF content in the coagulation solution within the range of 12-16%, a suitable solidification speed of the polyurethane coating layer can be obtained, and the shrinkage ratio of the obtained polyurethane waterproof coating layer is within the range of 0.1-0.3%. Preferably 15%, then the minimum shrinkage ratio can be obtained. The content of DMF is 12-16%.

Excessive DMF content may affect the coagulation speed, which may cause the coagulation speed to slow down and cause the solid content in the water to increase. When the content of DMF is excessively low, the recycling costs of DMF increases, the shrinkage ratio of the polyurethane waterproof layer increases, and the coating becomes thinner. By controlling the content of DMF between 12-16%, the curing speed is suitable, and the shrinkage ratio of the obtained polyurethane waterproof coating layer is in the range of 0.1-0.3%.

In step 6, the waterproof and breathable bib fabric prepared in step 5 is put into a washing tank for washing, and the liquid in the washing tank is pure water. After the polyurethane coating layer is completely solidified, a certain amount of DMF still remains in the porous layer, and these DMF must be forcibly removed in the washing tank, otherwise pitting may be formed on the PU coating layer after drying.

In step 7, in order to remove moisture, drying treatment is required, and the waterproof and breathable bib fabric prepared in step 6 is dried at 130° C. for 10-30 minutes.

In step 8, a water-repellent and oil-repellent agent is applied to the PU coating layer of the waterproof and breathable bib fabric prepared in step 7, and then the obtained easy-to-clean waterproof and breathable bib fabric is dried at 120° C. Herein, the composition of the water-repellent and oil-repellent agent used is 60% perfluoroalkyl acrylate polymer emulsion and 40% stearic acid amide methylene pyridinium chloride.

The composition of the water-repellent and oil-repellent agent described in step 8 is 60-80% perfluoroalkyl acrylate polymer emulsion and 40-20% stearic acid amide methylene pyridinium chloride. Fluorine-containing hydrocarbon compounds are oil-repellent agents, and the water-repellent effect is not ideal when used alone. However, the addition of pyridine water-repellent agents to fluorine-containing hydrocarbon compounds may not affect the original oil-repellent effect of fluorine-containing hydrocarbon compounds, and its water repellency and washability can also be improved.

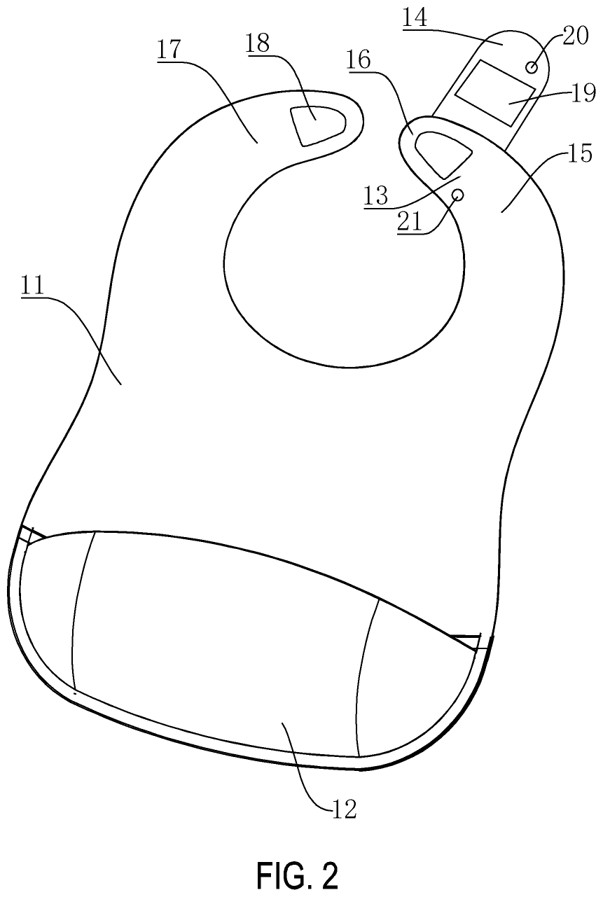

The abovementioned fabric is used for a bib, and an implementation of the structure of the bib is introduced as follows. As shown in FIG. 2, a bib body 12 for storing food residues and the bib cloth 11 made of the abovementioned fabric are included. The bib cloth 11 and the bib body 12 are sewn together or both are detachably connected, and the bib body may be made of silica gel or plastic that is able to maintain a certain shape. When food falls on the bib cloth 11 of the bib, due to the effect of the hydrophobic and oleophobic surface layer 1 and the polyurethane waterproof layer 2, the liquid therein cannot penetrate into the bib cloth 11 but slides rapidly into the bib body 12 of the bib. Further, the main body of the bib can be cleaned, and the performance of not adhering to dirt reduces the difficulty of cleaning the bib cloth 11 and also makes cleaning more convenient.

The bib cloth 11 includes a first strap 17 and a second strap 15, and a hook-and-loop fastener or a snap button is provided between the first strap 17 and the second strap 15. The second strap 15 is further provided with a reinforcing connecting ear piece 14 extending outwards. After the first strap 17 is connected to the second strap 15, the reinforcing connecting ear piece 14 covers the first strap 17 and is connected to the second strap 15 through the hook-and-loop fastener or the snap button. The reinforcing connecting ear piece 14 covers the connection between the first strap 17 and the second strap 15, so that the connection may not be easily disconnected when an external force is applied. Further, the reinforcing connecting ear piece 14 is connected to the second strap 15. In this way, if a child pulls the bib during use, the first strap 17 is prevented from being separated from the second strap 15, and that the protective function of the bib is prevented from failing.

Further, front and back surfaces of the first strap 17 are both provided with hook-and-loop fasteners or snap buttons. A main connecting zone 16 and a secondary connecting zone 13 are provided on the second strap 15, and the secondary connecting zone 13 is located beside the main connecting zone 16. A main body part of the reinforcement connecting ear piece 14 is correspondingly provided with a hook-and-loop fastener or a snap button. Since the connection between the first strap 17 and the second strap 15 belongs to the conventional manner in the field of bibs, description thereof is not provided in this embodiment. In this embodiment, the introduction is mainly made on the connection between the reinforcing connecting ear piece 14 and the second strap 15 and the first strap 17.

The hook-and-loop fastener is divided into a male tape 18 with a bun surface and a female tape 19 with a suede surface. The male tape 18 is disposed on the front surface of the first strap 17, and the female tape 19 is disposed on the reinforcing connecting ear piece 14. The snap button is divided into a male button 20 and a female button 21. The male button 20 is disposed on a head portion of the reinforcing connecting ear piece 14, and the female button 21 is disposed at the position of the secondary connecting zone 13 of the second strap 15.

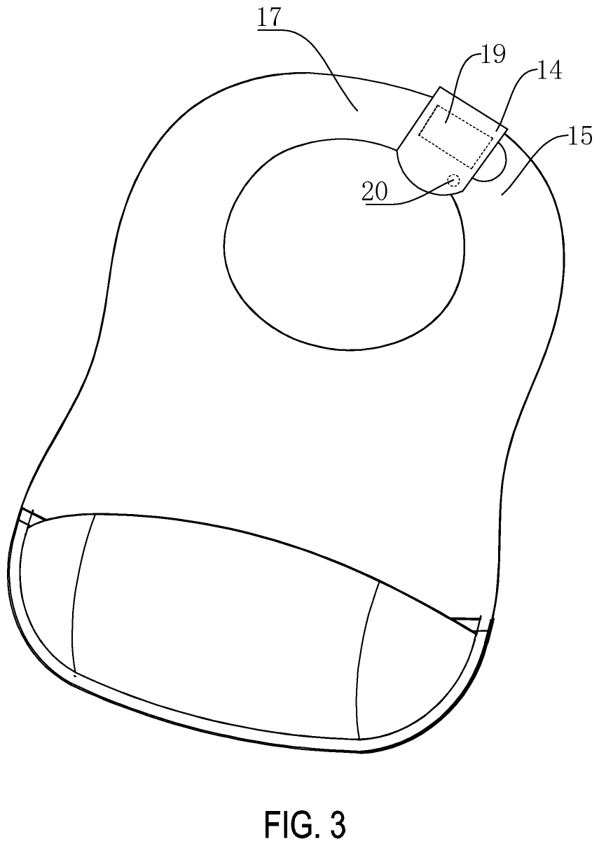

When wearing the bib, as shown in FIG. 2 and FIG. 3, after the hook-and-loop fastener on the back surface of the first strap 17 is connected to the hook-and-loop fastener on the main connecting zone 16 of the second strap 15, the corresponding female tape 19 on the reinforcing connecting ear piece 14 is connected to the male tape 18 on the front surface of the first strap 17. The male button 20 on the head portion of the reinforcing connecting ear piece 14 is then connected to the female button 21 on the secondary connecting zone 21 of the second strap 15 through the snap button. In this way, the reinforcing connecting ear piece 14 is not only connected to the second strap 15, but also connected to the first strap 17 at the same time, so the connection effect is further strengthened. Further, the connection manner of using the hook-and-loop fasteners or the snap buttons is convenient and simple to operate and may not cause trouble when putting on and taking off the bib, so the effectiveness of protection when the bib is in use is ensured.

Example 2: The difference between this example and Example 1 is that a method for processing an easy-to-clean waterproof and breathable bib fabric includes the following steps.

In step 1, the woven layer 4 and the antibacterial and antistatic layer 3 are bonded by a thermosetting polyurethane adhesive by thermocompression to prepare a two-layered water proof and breathable bib fabric. The thermosetting polyurethane adhesive is coated on the woven layer 4, and then the antibacterial and antistatic layer 3 is attached and dried at 150° C. for 10 minutes.

In step 2, a polyurethane waterproof layer stock solution is prepared. 100 parts of DMF is used, 10 parts of cellulose powder, 5 parts of nano-silver powder, 3 parts of ionic active agent, 0.5 part of defoaming agent, 0.2 part of leveling agent, and 0.2 part of anti-sticking agent are added. After stifling for 15 minutes, 90 parts of polyurethane emulsion are then added and stirred at high speed for 15 minutes for later use, and the content of the polyurethane resin is 30%.

In step 3, the two-layered waterproof and breathable bib fabric prepared in step 1 is immersed in clear water, and then the two-layered waterproof and breathable bib fabric is ironed to half-dry by an ironing wheel. The two-layered waterproof and breathable bib fabric is immersed in water to increase the humidity of the fabric and prevent the polyurethane waterproof layer stock solution to be coated from excessively penetrating into the base fabric. Further, the hydrophilicity of the base fabric having poor degreasing properties is improved.

In step 4, the polyurethane waterproof layer stock solution prepared in step 2 is uniformly coated on the antibacterial and antistatic layer of the two-layered waterproof and breathable bib fabric obtained in step 3 with a scraper.

In step 5, the waterproof and breathable bib fabric prepared in step 4 is put into a coagulation solution for 8 minutes, and the coagulation solution is composed of water and DMF, where the content of DMF is 15%.

In step 6, the waterproof and breathable bib fabric prepared in step 5 is put into a washing tank for washing, and the liquid in the washing tank is pure water. After the polyurethane coating layer is completely solidified, a certain amount of DMF still remains in the porous layer, and these DMF must be forcibly removed in the washing tank, otherwise pitting may be formed on the PU coating layer after drying.

In step 7, in order to remove moisture, drying treatment is required, and the waterproof and breathable bib fabric prepared in step 6 is dried at 130° C. for 20 minutes.

In step 8, a water-repellent and oil-repellent agent is applied to the polyurethane waterproof layer of the waterproof and breathable bib fabric prepared in step 7, and then the obtained easy-to-clean waterproof and breathable bib fabric is dried at 120° C. Herein, the composition of the water-repellent and oil-repellent agent used is 80% perfluoroalkyl acrylate polymer emulsion and 20% stearic acid amide methylene pyridinium chloride.

Other contents of this example are consistent with that of Example 1.

Detection Test:

The easy-to-clean waterproof and breathable bib fabric prepared in Examples 1 to 2 is tested for water-vapor transmission, water resistance, and antibacterial performance. The water-vapor transmission test is carried out according to the method of GB/T 12704-2009 “Textiles—Test method for water-vapor transmission of fabrics—Part 1: Desiccant method”. The water resistance test is carried out according to the method of GB/T 4744-2013 “Textiles—Testing and evaluation for water resistance”. The bacterial species detected by the antibacterial rate detection is Escherichia coli.

The specific data are shown in the table below:

| Item | Example 1 | Example 2 |
|---|---|---|
| Water-vapor Transmission g · m⁻² · 24 h⁻¹ | 4899 | 4945 |
| Hydrostatic pressure mmH₂O | 13000 | 12000 |
| Water Repellent Grade | 5 | 6 |
| Formaldehyde Content ppm | 11 | 13 |
| Bacterial Inhibition Rate % | 95 | 92 |
| Color Fastness to Dry Cleaning | 6 | 5 |
| Breaking Load N | 630 | 660 |
| Shrinkage Ratio % | 0.1 | 0.15 |

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An easy-to-clean waterproof and breathable bib fabric, wherein a layer structure of the fabric is as follows: a hydrophobic and oleophobic surface layer (1), a polyurethane waterproof layer (2), an antibacterial and antistatic layer (3), and a woven layer (4), wherein the hydrophobic and oleophobic surface layer (1) is arranged on an outermost side of the bib fabric, the hydrophobic and oleophobic surface layer (1) is coated on the polyurethane waterproof layer (2), the polyurethane waterproof layer (2) is attached to an outer surface of the antibacterial and antistatic layer (3), an inner surface of the antibacterial and antistatic layer (3) is tightly connected to one surface of the woven layer (4) by an adhesive, the other surface of the woven layer (4) is an innermost side of the fabric, and the four-layered structure is tightly combined to form a whole.

2. The easy-to-clean waterproof and breathable bib fabric according to claim 1, wherein the hydrophobic and oleophobic surface layer (1) is a hydrophobic and oleophobic surface layer formed by coating a water-repellent and oil-repellent agent on the polyurethane waterproof layer (2).

3. The easy-to-clean waterproof and breathable bib fabric according to claim 1, wherein the antibacterial and antistatic layer (3) is made of blending and weaving silver fibers and spandex.

4. The easy-to-clean waterproof and breathable bib fabric according to claim 1, wherein the adhesive is a thermosetting polyurethane adhesive.

5. The easy-to-clean waterproof and breathable bib fabric according to claim 1, wherein the woven layer (4) is a woven twill fabric.

6. A bib, comprising a bib body for storing food residues and a bib cloth (11) made of the fabric according to claim 1, wherein the bib cloth (11) and the bib body (12) are sewn together or both are detachably connected.

7. The bib according to claim 6, wherein the bib cloth (11) comprises a first strap (17) and a second strap (15), a hook-and-loop fastener or a snap button is provided between the first strap (17) and the second strap (15), the second strap (15) is further provided with a reinforcing connecting ear piece (14) extending outwards, and after the first strap (17) is connected to the second strap (15), the reinforcing connecting ear piece (14) covers the first strap (11) and is connected to the second strap (15) through the hook-and-loop fastener or the snap button.

8. The bib according to claim 7, wherein a main connecting zone (16) and a secondary connecting zone (13) are provided on the second strap (15), and the secondary connecting zone (13) is located beside the main connecting zone (16), the first strap (17) the is connected to the main connecting zone (16) of the second strap (15), and a head portion of the reinforcing connecting ear piece (14) is connected to the secondary connecting zone (13) of the second strap (15).

9. The bib according to claim 7, wherein front and back surfaces of the first strap (17) are both provided with hook-and-loop fasteners or snap buttons, a main body part of the reinforcement connecting ear piece (14) is correspondingly provided with a hook-and-loop fastener or a snap button, and after the back surface of the first strap (17) is connected to the main connecting zone (16) of the second strap (15), the front surface of the first strap (17) is correspondingly connected to the main body part of the reinforcing connecting ear piece (14) through the hook-and-loop fastener or snap button.

10. A preparation method of the easy-to-clean waterproof and breathable bib fabric according to claim 1, comprising:
step 1: bonding the woven layer (4) and the antibacterial and antistatic layer (3) by a thermosetting polyurethane adhesive by thermocompression to prepare a two-layered waterproof and breathable bib fabric;
step 2: preparing a polyurethane waterproof layer stock solution: taking 100 parts of DMF, then adding 5-10 parts of cellulose powder, 1-5 parts of nano-silver powder, 2-4 parts of ionic active agent, 0.1-0.5 part of defoaming agent, 0.1-0.3 part of leveling agent, and 0.1-0.3 part of anti-sticking agent, stirring for 10-20 minutes, then adding 80-100 parts of polyurethane emulsion, the mass percentage of polyurethane resin is 30%, and stifling at high speed for 10-20 minutes for later use;
step 3: immersing the two-layered waterproof and breathable bib fabric prepared in step 1 in clear water and then ironing the two-layered waterproof and breathable bib fabric to half-dry by an ironing wheel;
step 4: uniformly coating the polyurethane waterproof layer (3) stock solution prepared in step 2 with a scraper on the antibacterial and antistatic layer of the two-layered waterproof breathable bib fabric obtained in step 3;
step 5: putting the waterproof and breathable bib fabric prepared in step 4 into a coagulation solution for 5-10 minutes, and the coagulation solution is composed of water and DMF;
step 6: putting the waterproof and breathable bib fabric prepared in step 5 into a washing tank for washing, and the liquid in the washing tank is pure water;
step 7: drying the waterproof and breathable bib fabric prepared in step 6 at a temperature of 120-150° C. for 10-30 minutes; and
step 8: brushing a water-repellent and oil-repellent agent on the polyurethane waterproof layer of the waterproof breathable bib fabric prepared in step 7 and then drying the obtained easy-to-clean waterproof and breathable bib fabric at 120-140° C.

11. The preparation method of the easy-to-clean waterproof and breathable bib fabric according to claim 10, wherein the coagulation solution described in step 5 has a DMF content of 15-20%.

12. The preparation method of the easy-to-clean waterproof and breathable bib fabric according to claim 10, wherein the composition of the water-repellent and oil-repellent agent described in step 8 is 60-80% perfluoroalkyl acrylate polymer emulsion and 40-20% stearic acid amide methylene pyridinium chloride.
